(19) United States
(12) Patent Application Publication
(10) Pub. No.: US 2002/0120786 A1
(43) Pub. Date: Aug. 29, 2002

(54) System and method for managing application integration utilizing a network device

(76) Inventors: Ilan Sehayek, Belmont, CA (US); Carlos Mendez, San Francisco, CA (US); Orr Shakked, Oakland, CA (US); Doron Rotem, Oakland, CA (US); Per Henrik Nordberg, Walnut Creek, CA (US); Shung-Yang Frank Chu, Kensington, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/006,804

(22) Filed: Dec. 4, 2001

Related U.S. Application Data
(60) Provisional application No. 60/251,253, filed on Dec. 4, 2000.

(51) Int. Cl. G06F 15/163; G06F 9/54; G06F 9/00; G06F 15/16

(52) U.S. Cl. 709/310; 709/204

(57) ABSTRACT

A system and method for providing application integration are provided. A network device having application integration functionality is configured such that the network device is accessible, configurable and maintainable through a network connection. The network device is integrated into organizational networks by end users via web page interfaces and network capable client-side interfaces that allow system users and administrators to manage the system. Additionally, the network device is accessible via a network for providing updates, upgrades, and integration templates and proactively maintaining the network device. The network device is then utilized to provide a variety of application integration functionality.

### CROSS-REFERENCE TO RELATED APPLICATION

This application claims the benefit of U.S. Provisional Application No. 60/251,253 entitled SYSTEM AND METHOD FOR MANAGING APPLICATION INTEGRATION and filed on Dec. 4, 2000. U.S. Provisional Application No. 60/251,253 is incorporated by reference herein.

### FIELD OF THE INVENTION

In general, the present invention relates to computer networks, and in particular, to a system and method for implementing a function specific network device, such as a network appliance, for interchanging dissimilarly formatted data between computer system software applications.

### BACKGROUND OF THE INVENTION

Generally described, an organization, such as a corporation, may utilize several network applications to perform a variety of tasks. For example, a corporation may utilize a first computer system having proprietary software application to run its accounting processes, a separate computer system having proprietary software application to manage purchase order requests and yet another computer system located at a remote partner site having software application that contains inventory information. In some situations, the corporation often needs to exchange data between these software applications. For example, the purchase order request software application often will need to communicate processed purchase orders to the inventory software application. Often, however, the data formats incorporated in each software application are sufficiently different to make a data interchange between the computer systems difficult, if not impossible.

One attempt to provide a data interchange on a network generally involves utilizing a server computer to run integration software. In such an embodiment, the server computer is configured with integration software to the organization's network with the ability to acquire, translate and deliver data between software applications both within the organization and between organizations. Additionally, the integration configured server computer can also be utilized to automate business processes by managing how information is exchange between system according to business workflows. The utilization of integration software to provide data interchangeability and manage workflows provides an organization increased network flexibility and software application interaction.

In a typical embodiment, the use of the data interchange and workflow software often requires a stand alone computer server which must be configured to the organization network. Although the computer server is generally dedicated to providing the data interchange and workflow integration functionality, skilled persons are often required to install the software integration applications, configure the server computer to the particular network, and maintain the integration software. The specialized skill sets are associated to proprietary knowledge of the integration software to facilitate the data interchange and workflow automation and the requirements/resources of the organization's network. Moreover, because the integration software applications require a dedicated server computer to implement the system, the cost of implementing software solution becomes increasingly higher with the addition of the required computer server hardware and associated network configurations.

Thus, there is a need for a system and method for implementing application integration functionality while mitigating upfront hardware or network requirements and associated integration system installation, configuration and management skill requirements. Additionally, there is a need for a lower cost application integration server solution that is pre-packaged to allow a system user to obtain the integration functionality in an efficient manner.

### SUMMARY OF THE INVENTION

A system and method for providing application integration are provided. A network device having application integration functionality is configured such that the network device is accessible, configurable and maintainable through a network connection. The network device is integrated into organizational networks by end users via web page interfaces and network capable client-side interfaces that allow system users and administrators to manage the system. Additionally, the network device is accessible via a network for providing updates, upgrades, and integration templates and proactively maintaining the network device. The network device is then utilized to provide a variety of application integration functionality.

In accordance with an aspect of the present invention, a network device for providing an automatic exchange of data between two or more software applications connected to a network is provided. The network device hardware includes a processor operable to execute computer-readable instructions. The network device also includes a mass memory including one or more computer-readable components for providing integration functionality. The network device further includes a network interface in communication with a network. The network interface is operable to obtain data from one or more software applications and transmit processed data. However, the network device does not include any input devices or display devices for control. Rather, end users or system administrators can utilize a remote browser and/or client-side tools to interface with the network device.

In accordance with another aspect of the present invention, an integration system is provided. The integration system includes one or more computing devices including at least one software application operable to transmit and receive data. The data interchange system also includes one or more network devices connected to the communication network. Each network device is operable to generate a user interface for configuring the network device to the data interchange system. However, the network device does not include a display device. The data interchange system further includes at least one computing device having a browser thereon. The computing device is remote from the network device and operable to display the user interface for configuring the network device. In accordance with still a further aspect of the present invention, a network device maintenance service for a network device in a communication network is provided. The network device maintenance service provides updates, upgrades and integration templates to the network device and automatically monitors and maintains the network system and hardware.

In accordance with still a further aspect of the present invention, a network device for providing a data interchange between two or more software applications connected to the network is provided. The network device includes a processor operable to execute computer-readable instructions. The network device also includes means for providing data interchange and network interface means for obtaining data from one or more software applications and transmitting processed data. However, the network device does not include any input devices or display devices for control.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a representative portion of the Internet;

FIG. 2 is a block diagram illustrative of a data interchange system in accordance with the present invention;

FIG. 3 is a block diagram illustrative of a network device in accordance with the present invention;

FIG. 4 is a block diagram of the data interchange system of FIG. 2 illustrative a data interchange process in accordance with the present invention;

FIG. 5 is an exemplary illustration of a screen display generated by the network device of FIG. 3 for providing a transformation process manager for generating a workflow in accordance with the present invention;

FIG. 6 is an exemplary illustration of a screen display generated by the network device of FIG. 3 for configuring the network device and for managing various components within the network device; and

FIG. 7 is an exemplary illustration of a screen display generated by the network device of FIG. 3 for interfacing with an external database in accordance with the present invention.

### DETAILED DESCRIPTION OF THE PREFERRED EMBODIMENT

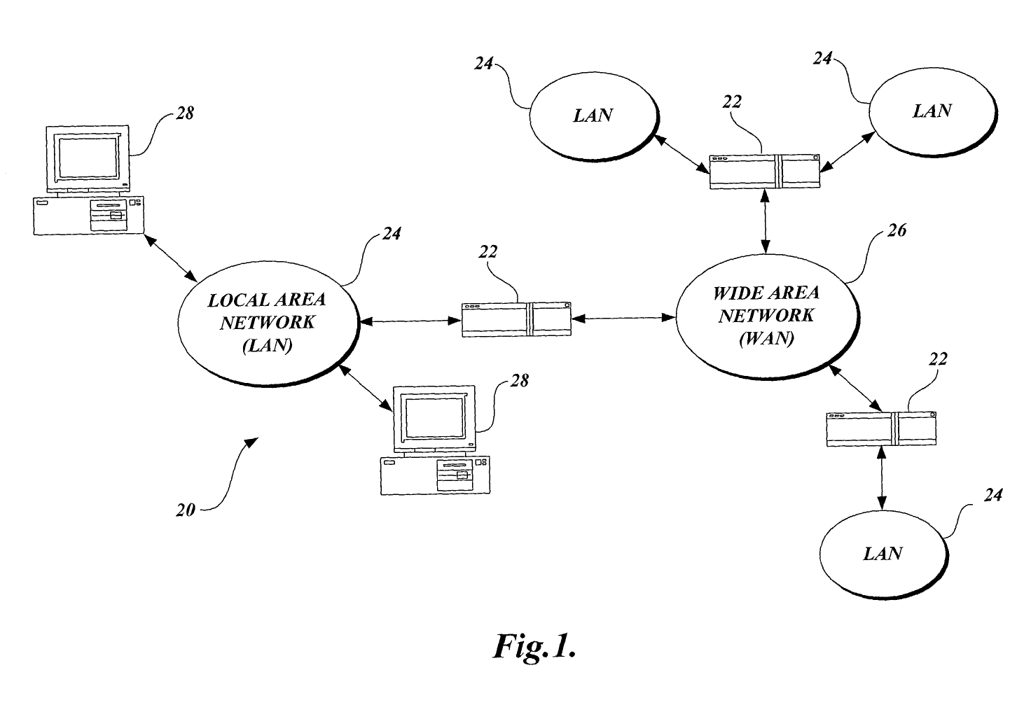

As described above, aspects of the present invention are embodied in a World Wide Web (“WWW” or “Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication links between networks may utilize 56 Kbps analog telephone lines, 1 Mbps digital T-1 lines, 45 Mbps T-3 lines, or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”) or other markup languages, which are electronically stored at “WWW sites” or “Web sites” throughout the Internet. Other interactive hypertext environments may include proprietary environments, such as those provided in America Online or other online service providers, as well as the “wireless Web” provided by various wireless networking providers, especially those in the cellular phone industry. It will be appreciated that the present invention could apply in any such interactive hypertext environments; however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents. Embedded within a hypertext document are a number of hyperlinks, i.e., highlighted portions of text that link the document to another hypertext document possibly stored at a Web site elsewhere on the Internet. Each hyperlink is assigned a Uniform Resource Locator (“URL”) that provides the exact location of the linked document on a server connected to the Internet and describes the document. Thus, whenever a hypertext document is retrieved from any Web server, the document is considered retrieved from the World Wide Web. Known to those skilled in the art, a Web server may also include facilities for storing and transmitting application programs, such as application programs written in the JAVA® programming language from Sun Microsystems, for execution on a remote computer. Likewise, a Web server may also include facilities for executing scripts and other application programs on the Web server itself.

A consumer or other remote access user may retrieve hypertext documents from the World Wide Web via a Web browser program. A Web browser, such as Netscape's NAVIGATOR® or Microsoft's Internet Explorer, is a software application program for providing a graphical user interface to the WWW. Upon request from the consumer via the Web browser, the Web browser locates and retrieves the desired hypertext document from the appropriate Web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the Web server, such as JAVA applets, for execution on the client computer.

The present application relates to a system and method for configuring and controlling the exchange of data amongst applications in a WAN or LAN network. More specifically, the present invention will be described in relation to a system and method for utilizing a network device to remotely control data interchange or business workflow functionality in a network. An illustrative software application that allows a server computer to automate the obtaining of data in a first format, translate the data into another format and then deliver the translated format is found in co-pending patent application U.S. patent application Ser. No. 09/524,995, entitled SYSTEM AND METHOD FOR AUTOMATING BUSINESS PROCESSES AND PERFORMING DATA INTERCHANGE OPERATIONS IN A DISTRIBUTED COMPUTING ENVIRONMENT and filed on Mar. 14, 2000. U.S. application Ser. No. 09/524,995 is incorporated by reference herein. Additionally, although the present invention will be described with regard to the data interchange functionality, one skilled in the relevant art will appreciate that the disclosed embodiment is illustrative in nature and should not be construed as limiting.

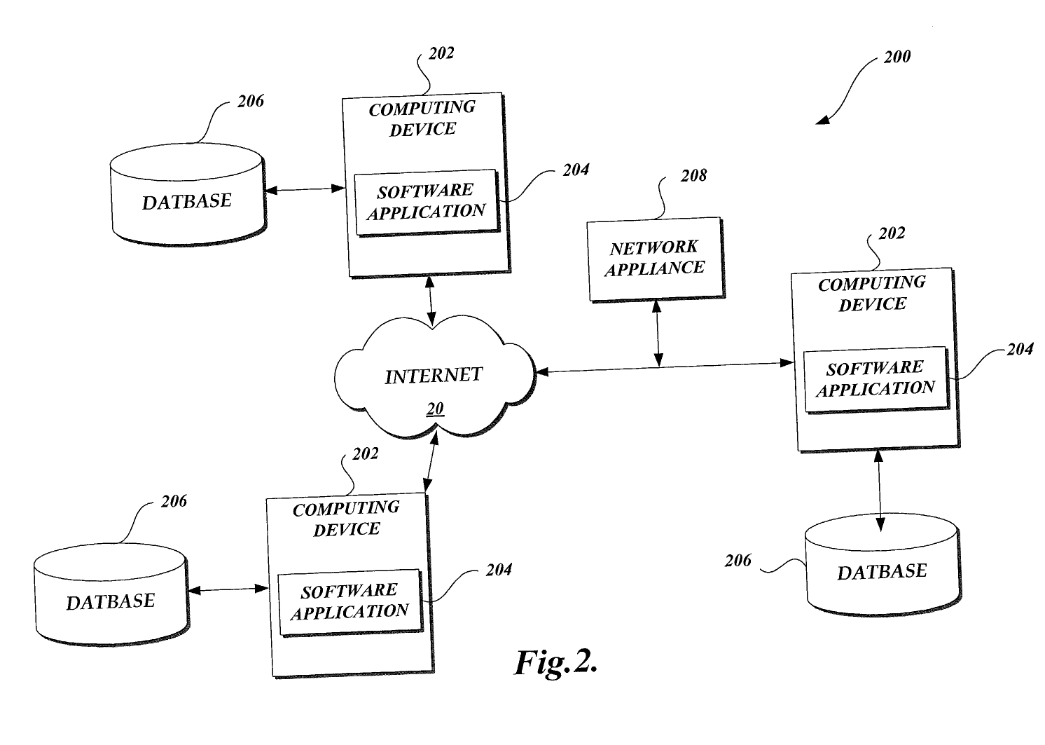

FIG. 2 is a block diagram illustrative of a data interchange network 200 in accordance with the present invention. The data interchange network 200 includes a number of computing devices 202 having on them one or more software applications 204. Each of the computing devices 202 is interconnected with one another via a network connection such as a LAN or a WAN. The software applications 204 store data in an established format and are operable to transfer the stored data to one or more other computing devices 202 via a variety of network transfer protocols. As illustrated in FIG. 2, each computing device 202 may include one or more databases 206 that are operable to store data obtained by or generated by the software application 204. One skilled in the relevant art will appreciate that the computing devices 202 can include a number of computing devices including, but not limited to, desktop personal computers (“PC”), server computing devices, hand-held computing devices, mobile telephones, and the like. Moreover, one computing device 202 may include more than one software application 204 for transferring data.

Also connected to the network is a network device 208 utilized to translate the data from a first format to a second format and to automate that movement from one network location to another. In one embodiment, the network device 208 directs and translates outputted data from one software application and network location to one or many software applications and network locations. In another embodiment, the network device 208 is configured on the network such that it monitors and identifies data transfers on the network that require translation. In either configuration, the network device 208 of the present invention serves as a tool for providing seamless application layer to application layer data interchange.

In an actual embodiment of the present invention, the network device 208 is a stand-alone server computer that can be implemented in a variety of network configurations. Specifically, the network device 208 is organized such that it does not include any display or input devices and can only be accessed via a network connection, such as through the Internet or an Intranet. Accordingly, the network device 208 can only be remotely initialized and controlled by the network administrators. Moreover, in an actual embodiment of the present invention, the network device 208 is constructed such that it can fit into a rack-type system. This construction facilitates the physical security of the network device 208 and the use of the network device 208 into pre-existing networks and the use of multiple network devices 208.

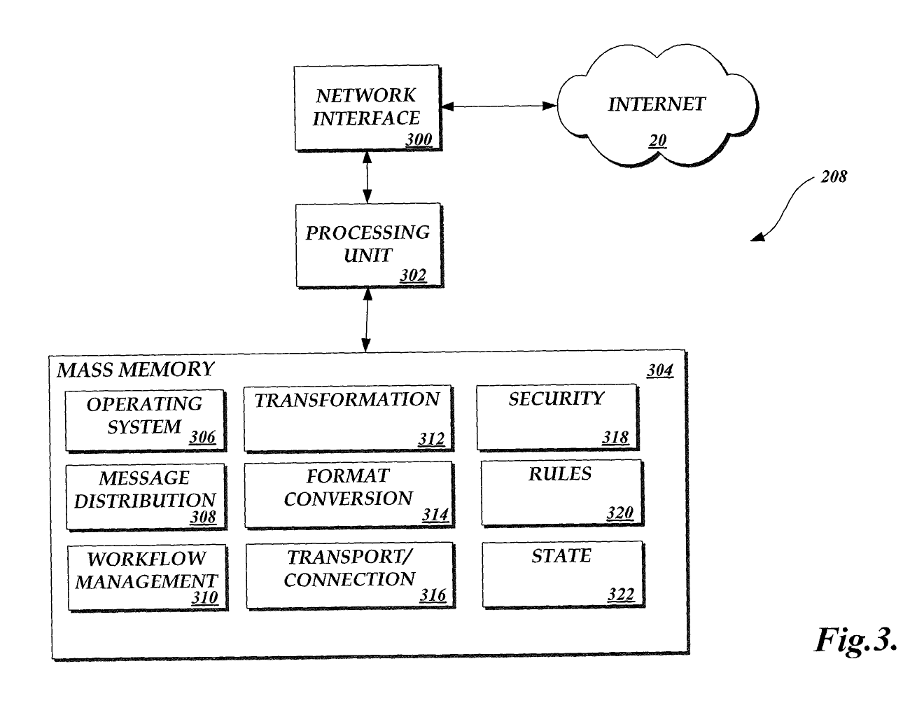

FIG. 3 is a block diagram depicting an illustrative architecture for the network device 208. Those of ordinary skill in the art will appreciate that the network device 208 includes many more components then those shown in FIG. 3. However, it is not necessary that all of these generally conventional components be shown in order to disclose an illustrative embodiment for practicing the present invention. As shown in FIG. 3, the network device 208 includes a network interface 300 for connecting directly to a LAN or a WAN, or for connecting remotely to a LAN or WAN. Those of ordinary skill in the art will appreciate that the network interface 300 includes the necessary circuitry for such a connection, and is also constructed for use with the TCP/IP protocol or other protocols, such as Internet Inter-ORB Protocol (“IIOP”). The network device 208 may also be equipped with a modem for connecting to the Internet through a PPP connection or a SLIP connection as known to those skilled in the art.

The network device 208 also includes a processing unit 302 and a mass memory 304, all connected via a communication bus, or other communication device. The mass memory 304 generally comprises a RAM, ROM, and a permanent mass storage device, such as a hard disk drive, tape drive, optical drive, floppy disk drive, or combination thereof. The mass memory 304 stores an operating system for controlling the operation of the network device 208. It will be appreciated that this component may comprise a general-purpose server operating system as is known to those skilled in the art, such as UNIX, LINUX™, or Microsoft WINDOWS NT®.

The mass memory 304 also stores program code and data for interfacing with the various software applications to provide the network integration functions in accordance with the present invention. More specifically, the mass memory 304 stores a various network integration components that may be utilized to provide the various network integration functions. In an illustrative embodiment of the present invention, the components of the mass memory 304 can operate in either a synchronous messaging embodiment or in an asynchronous embodiment. With reference to FIG. 3, the mass memory 304 can include a message distribution component 308 for providing communication functionality between software applications 204 and a workflow component 310 for providing workflow functionality to a system 200. The workflow management component 310 can include workflow routing, workflow escalation and any additional sub-components for scheduling and executing workflows within a network, such as network 200. The mass memory 304 can also include a transformation component 312 for providing data transformation functionality between two or more software applications 204 and a format conversion component 314 for providing data conversion functionality between two or more software applications 204. Still further, the mass memory 304 can include a transport/connection component 316 and a security component 318. In an illustrative embodiment of the present invention, the format conversion component 314 and the transport/connection component 316 can process and utilization any one of a variety of data and communication protocols including, but not limited to, XML, EDI, SMTP, HTTP, SOAP, IIOP. The mass memory 304 can include a rules component 320 and state component 322 that allow a system user to implement how the various components of the network device 208 are implemented and for the network device 208 to execute the software integration functionality. It will be appreciated that these components may be stored on a computer-readable medium and loaded into the memory of the network device 208 using a drive mechanism associated with the computer-readable medium, such as a floppy, CD-ROM, DVD-ROM drive, or network drive 300.

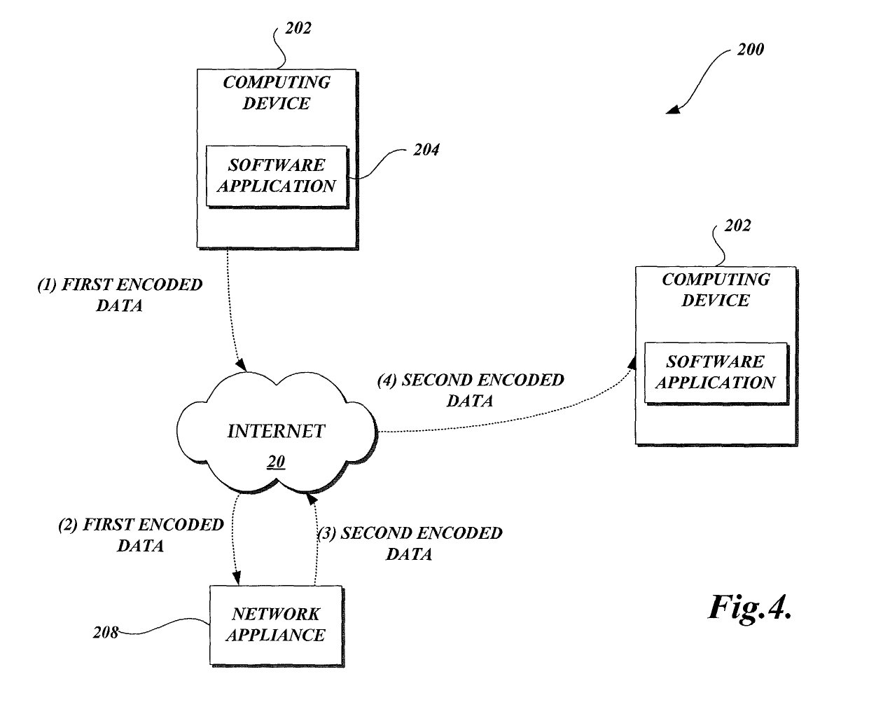

With reference now to FIG. 4, an illustrative data interchange process with regard to the data interchange system 200 will be described. A first software application 204 on a computing device 202 generates and transmits data encoded in a first data format. One or more network devices 208, in communication with the communication network, such as the Internet 20 or a network intranet, obtain the transmitted data from the first software application. In an illustrative embodiment of the present invention, the transmitted data may include data identifying a second computing device 202 to receive the data. Alternatively, the data from the first software application 204 may be directly sent to a network device 208 for translating. The network device 208 translates the encoded data into a second format and transmitted the translated data to designated second computing device 202.

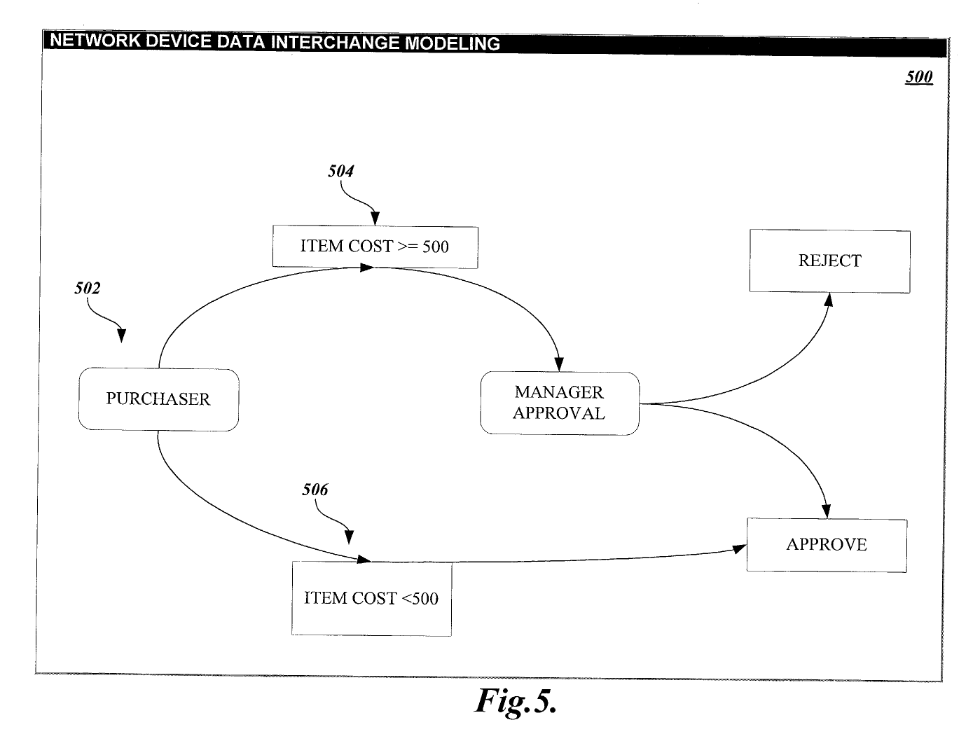

In another embodiment of the present invention, the data interchange system 200 may also be utilized to implemented document workflow processes in accordance with the present invention. Document workflow processes allow the automatic processing of business documentation, such as purchase order requests. For example, any user the network device 208 may be able to automatically make decisions regarding purchase orders without requiring human intervention. FIG. 5 is a screen shot 500 illustrative of the client used to design processes associated to executing data interchanges and integrating into systems databases, component object model (“COM”), common object request broker architecture (“CORBA”) and enterprise JavaBeans (“EJB”) objects. These processes typically involve managing data interchange resolutions, compilations of complex data sets, de-compilations of complex data sets and escalations. As illustrated in FIG. 5, a system administrator may access the screen display 500 via a remote computing device having a browser and a display. The system administrator may define various objects 502, 504 and 506 that can dictate how web workflows are defined. The utilization of software to implement the data interchange and web workflows is found in co-pending U.S. application Ser. No. 09/524,995, and will not be described in greater detail below.

In one aspect of the present invention, the network device 208 is operable to be configurable to an existing network without utilizing Dynamic Host Configuration Protocol (“DHCP”) and/or NetBIOS configuration services. One skilled in the relevant art will appreciate that DHCP environments in a computer network automatically assign networking information to a computer when it boots. NetBIOS name services in a computer network provide simple name resolution of computer names to IP addresses. Both services, however, typically require a computing device, such as a server computer, that include display and input devices to properly configure a computer to a network. The device thus enables static IP configuration.

In accordance with this aspect of the present invention, the network device 208 can be configured to an existing system without requiring a system administrator to utilize a display and input devices. In accordance with this embodiment, a system administrator initializes a network interface for the network device 208 by accessing a remote web site and configuring a memory device, such as floppy disk, with initialization information. The memory device is inserted into a memory interface, such as floppy disk drive, of the network device 208 and the network device 208 is powered up. Upon detecting the presence of the memory device, the network device 208 will store its network configuration information on the memory device. In an embodiment in which there is DHCP connectivity, the network device 208 will store the DHCP values on the memory device.

Once the network device 208 has stored data onto the memory device, the system administrator then ejects the memory device and accesses the data on the memory device by utilizing a computer system having both display and input devices. The system administrator then modifies the information on the memory device to properly configure the network device 208. The system administrator reinserts the memory device into the network device 208 and the network device 208 implements the modified configuration information.

Utilizing the memory device to allow a system administrator to configure the network device 208 eliminates the need for display and input devices. In an alternative embodiment, the network device 208 may also be configured with a LCD display and keypad to facilitate the initialization of the network device 208. Once the network device 208 is initialized to the network, the system administrator utilizes an administration web page to remotely finish configuring the network device 208.

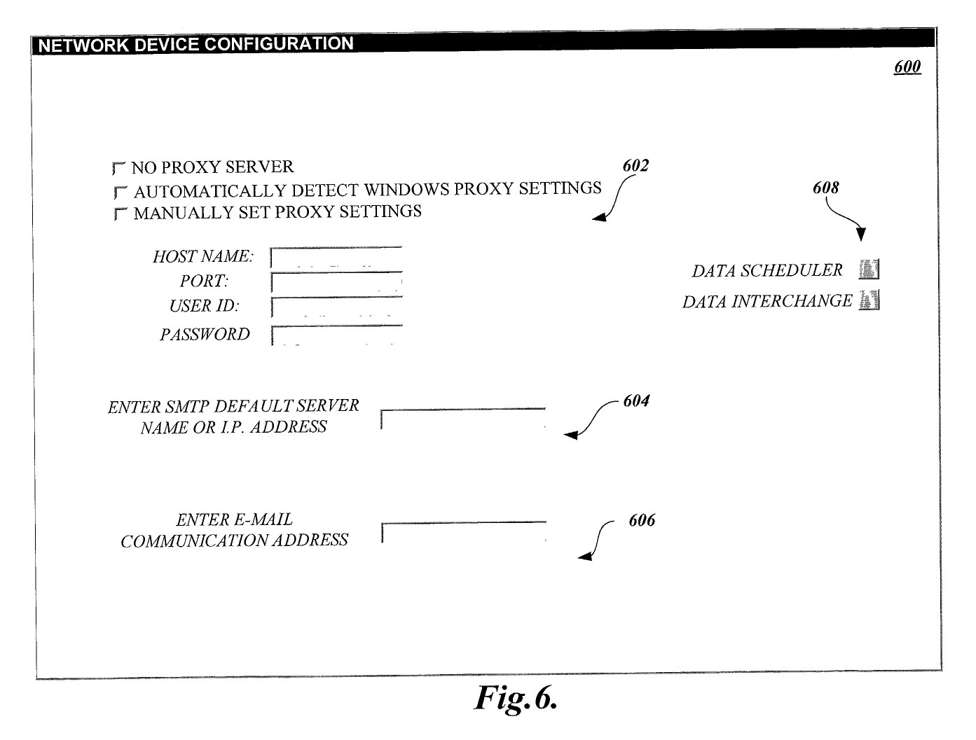

FIG. 6 is a block diagram illustrative of a screen display 500 for configuring the network device 208. As illustrated in FIG. 6, the screen display 600 includes a plurality of fields that allows the system administrator may configure basic settings via the screen display 600. More specifically, in an illustrative embodiment of the present invention, the screen display 600 includes a set of fields 602 for configuring a proxy server, a field 604 for configuring an IP address and a field 606 for entering e-mail addresses for communication. Additionally, the screen display 600 includes one or more buttons 608 for implementing data interchange and web workflow functions of the data interchange system 200. In an illustrative embodiment of the present invention, any computing device having a Web browser and a display screen can generate the screen display 600. Accordingly, the system administrator may remotely configure the network device 208 via the screen interface 600

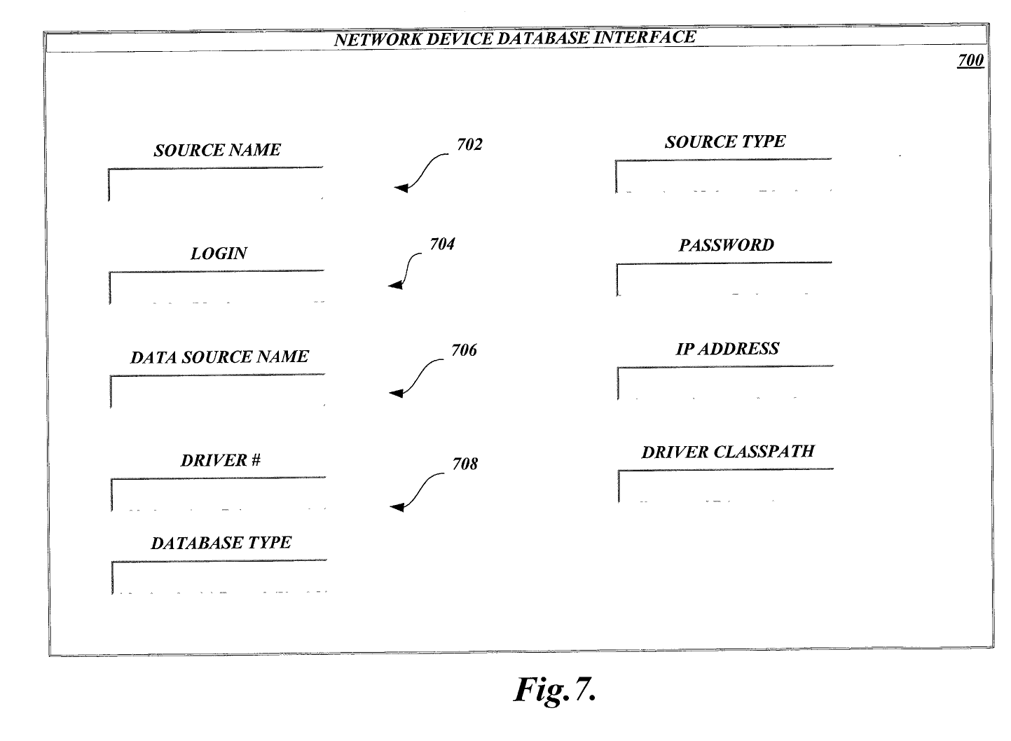

In a further aspect of the present invention, the network device 208 is configured to access network databases without utilizing data server name (“DSN”) services. In a conventional embodiment, interfacing with external databases involves access to a DSN. However, DSN access requires display and input devices on the server computer. Accordingly, the present invention overcomes the display and input device requirements by providing a database connection user interface for allowing a system administrator to choose between a DSN connection to the database and a connection to the database via connection screen. FIG. 7 is a block diagram illustrative of a screen display 700 for configuring the DSN connection of the network device 208. The screen display 700 includes a number of fields for setting the DSN configuration settings. More specifically, the screen display 700 includes a set of fields 702 for configuring the source, a set of fields 704 for setting security access information, a set of fields 706 for configuring a data source, and a field for dictating the type of database. Similar to screen display 600, the DSN configuration screen display 700 is generated by any computing having a browser and a display device such that a system administrator can configure the DSN settings remotely.

In another aspect of the present invention, because the network device 208 is a closed system, the network device 208 is configured to automatically back up its data into a database at preassigned intervals. In one aspect of the present invention, the network device 208 utilizes a tool or network component to create and store the backup files. In an alternative embodiment, the network device 208 utilizes its data interchange functionality to obtain, translate and deliver its backup data to one or more databases on the network.

In another aspect of the present invention, the network device 208 is also configured to accept and implement software upgrades, updates patches to the data integration software and/or the operating environment, and additional integration templates. In accordance with this embodiment of the present invention, the network device 208 can be implemented in manner such that the system administrator is unable to access the data interchange software and/or the operating environment. In one embodiment, the network device 208 utilizes an external network, such as the Internet, to contact a web site authorized to issue upgrades to the integration application and/or the operating environment. Accordingly, the network device 208 downloads and implements the upgrade. One skilled in the relevant art will appreciate that the authorized web site may issue a communication to each network device 208 to seek an upgrade. Alternatively, the network device 208 may also be configured to check for upgrades at specific time intervals. Additionally, the system administrator may also direct the network device 208, through a network web page, to communicate with the authorized web site. Still further, the network device 208 may also be configured to perform hardware status checks and report the data to the remote service for hardware corrections.

In another embodiment, the network device 208 may not have direct external network access. In such an embodiment, a system administrator contacts the authorized web site and downloads and stores the upgrade to a third party computer connected to the organization network. The system administrator then transfers the download to the network device 208 via an internal network.

In an illustrative embodiment of the present invention, multiple network devices 208 may be utilized in an organization network. Each network device 208 may be utilized for a limited number of specialized tasks. Additionally, each network device 208 may be modified specifically to implement the assigned task. For example, assume a network device 208 is utilized solely for translated data from a first format to a second format. While the general network device 208 would include a vast library of formats, which it could accept and translate, the dedicated network device 208 would be modified to execute more efficiently by eliminating the unused library data. In one embodiment, a system administrator would configure the network device 208 by specifying the network device 208 task via a web site interface.

In another illustrative embodiment of the present invention, multiple network devices 208 may also be utilized to provide fault tolerance. In such an embodiment, the two or more network devices 208 would be connected to the network in parallel. In the event a primary network device 208 would fail, one or more backup network devices 208 would provide the data interchange functionality.

In yet another illustrative embodiment, multiple network devices 208 may also be utilized to provide network scalability. In such an embodiment, the two or more network devices 208 would be connected in series to provide the data interchange functionality. For example, assume a data interchange involves a large amount of data computation. Each network device 208 would be configured to provide a portion of the data computation to increase the speed and capacity to process larger amounts of data.

In yet another illustrative embodiment all network device 208 are configured to exchange data transformation definitions amongst units. In such an embodiment, two or more network device 208 would be able to transmit to each other specific data transformation definitions in order to establish a future exchange of data. For example, a user could transmit its extended markup language (“XML”) data format to other devices linked into their central unit. Those subscribing units could accept the new formats and begin to integrate with them. Each network device 208 would be configured to provide the ability to accept and transmit integration definitions to other network devices 208.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A network device for providing a data interchange between two or more software applications connected to the network, the device comprising:
a processor operable to execute computer-readable instructions;
a mass memory including one or more computer-readable components operable to process data from one or more software applications;
a network interface in communication with a communication network interface operable to obtain data from one or more transmitting software applications and transmit processed data to one or more receiving software applications;
wherein the network device does not include any input devices or display devices for control.

2. The network device as recited in claim 1, wherein the computer-readable components include a workflow component operable to schedule and execute workflows between the two or more software applications.

3. The network device as recited in claim 1, wherein the computer-readable components include a message distribution component operable transmit messages between the two or more software applications.

4. The network device as recited in claim 3, wherein the data interchange interface is a graphical user interface.

5. The network device as recited in claim 4, wherein the graphical user interface is a Web-based graphical user interface.

6. The network device as recited in claim 1, wherein the network interface is further operable to generate one or more interfaces for configuring the network device to the communication network.

7. The network device as recited in claim 6, wherein the one or more interfaces include a graphical user interface for configuring the communication settings for the network device.

8. The network device as recited in claim 7, wherein the graphical user interface is operable to designate a network I.P. address.

9. The network device as recited in claim 1 further comprising an LCD display for configuring the acceptance of a memory device, the memory device for loading system initialization information.

10. The network device as recited in claim 1, wherein the network interface is further operable to communicate with an external maintenance service to obtain maintenance information.

11. The network device as recited in claim 10, wherein the maintenance information update, upgrade and integration templates.

12. A data interchange system, the system comprising:
one or more computing devices, each computing device including at least one software application operable to transmit and receive data;
one or more network devices connected to a communication network, wherein the network device is operable to generate a user interface for configuring the network device to the data interchange system and wherein the network device does not include a display device; and
at least one computing device having a browser thereon, the computing device remote from the network device and operable to display the user interface for configuring the network device.

13. The data interchange system as recited in claim 12, wherein the data interchange system includes two or more network devices, wherein each networked device is configured to a particular data interchange function.

14. The data interchange system as recited in claim 13, wherein one of the two or more network devices is dedicated to primarily data computation.

15. The data interchange system as recited in claim 12, wherein the data interchange system includes two or more network devices and wherein a first network device and a second network device are connected in parallel.

16. The data interchange system as recited in claim 15, wherein the first and second network devices distribute all processing tasks.

17. The data interchange system as recited in claim 12, wherein the network device is further operable to obtain software updates from a remote third party and implement the updates without providing access to the software to the computing device.

18. The data interchange system as recited in claim 17, wherein the remote third party is further operable to transmit integration templates.

19. The data interchange system as recited in claim 17, wherein the remote third party is further operable to transmit software upgrades.

20. The data interchange system as recited in claim 12, wherein the user interface for configuring the network device is a graphical user interface.

21. The data interchange system as recited in claim 20, wherein the graphical user interface is a Web-based graphical user interface.

22. A network device for providing a data interchange between two or more software applications connected to the network, the device comprising:
a processor operable to execute computer-readable instructions;
means for providing software integration;
network interface means for obtaining data from one or more software applications and transmitting processed data;
wherein the network device does not include any input devices or display devices for control.

23. The network device as recited in claim 22, wherein the means for providing software integration include a workflow component operable to schedule and execute workflows between the two or more software applications.

24. The network device as recited in claim 22, wherein the means for providing data integration includes a message distribution component operable transmit messages between the two or more software applications.

25. The network device as recited in claim 22, wherein the data interchange interface is a graphical user interface.

26. The network device as recited in claim 25, wherein the graphical user interface is a Web-based graphical user interface.

27. The network device as recited in claim 22, wherein the network interface means is further operable to generate one or more interfaces for configuring the network device to a network.

28. The network device as recited in claim 27, wherein the one or more interfaces include a graphical user interface for configuring the communication settings for the network device.

29. The network device as recited in claim 28, wherein the graphical user interface is operable to designate a network I.P. address.

30. The network device as recited in claim 22 further comprising display means for configuring the acceptance of a memory device, the memory device for loading system initialization information.

31. The network device as recited in claim 22, wherein the network interface is further operable to communicate with an external maintenance service to obtain maintenance information.

32. The network device as recited in claim 31, wherein the maintenance information update, upgrade and integration templates.
